(19) United States
(12) Patent Application Publication
(10) Pub. No.: US 2019/0391915 A1
(43) Pub. Date: Dec. 26, 2019

(54) MEMORY SYSTEM AND OPERATING MEHTOD THEREOF

(71) Applicant: SK hynix Inc., Gyeonggi-do (KR)

(72) Inventors: Se-Hyun KIM, Seoul (KR); Byeong-Gyu PARK, Gyeonggi-do (KR)

(21) Appl. No.: 16/237,264

(22) Filed: Dec. 31, 2018

(30) Foreign Application Priority Data
Jun. 20, 2018 (KR) 10-2018-0070580

(51) Int. Cl. G06F 12/02; G06F 3/06; G06F 11/10

(52) U.S. Cl. CPC G06F 12/0246; G06F 3/0659; G06F 3/0679; G06F 2212/7201; G06F 11/1068; G06F 2212/401; G06F 11/1044

(57) ABSTRACT

An operating method of a memory system includes receiving a read request for sequential target user data; determining whether compressed target map data corresponding to the read request are retrieved from a map cache region within a memory; loading the compressed target map data and compressed candidate map data from a memory device of the memory system, when the compressed target map data are not retrieved from the map cache region, the compressed candidate map data being selected from among compressed map data in a compressed map table, according to a rule; and storing the loaded compressed target map data and compressed candidate map data in the map cache region.

### CROSS-REFERENCE TO RELATED APPLICATION

The present application claims priority under 35 U.S.C. § 119(a) to Korean Patent Application No. 10-2018-0070580, filed on Jun. 20, 2018, the disclosure of which is incorporated herein by reference in its entirety.

### BACKGROUND

### 1. Field

Various embodiments of the present invention relate to a memory system. Particularly, various embodiments relate to a memory system capable of efficiently performing a read operation, and an operating method thereof.

### 2. Description of the Related Art

The computer environment paradigm has moved towards ubiquitous computing, which enables computing systems to be used anytime and anywhere. As a result, the demand for portable electronic devices, such as mobile phones, digital cameras, and laptop computers have increased rapidly. Those electronic devices generally include a memory system using a memory device as a data storage device. The data storage device may be used as a main memory or an auxiliary memory of a portable electronic device.

Since there is no mechanical driving part, a data storage device using a memory device provides advantages such as excellent stability and durability, high information access speed, and low power consumption. Also, such data storage device can have a quick data access rate with low power consumption compared to a hard disk device. Non-limiting examples of the data storage device having such advantages include universal serial bus (USB) memory devices, memory cards of diverse interfaces, solid state drives (SSDs), and the like.

### SUMMARY

Various embodiments of the present invention are directed to a memory system capable of efficiently processing map data.

In accordance with an embodiment of the present invention, an operating method of a memory system may include: receiving a read request for sequential target user data; determining whether compressed target map data corresponding to the read request are retrieved from a map cache region within a memory; loading the compressed target map data and compressed candidate map data from a memory device of the memory system, when the compressed target map data are not retrieved from the map cache region, the compressed candidate map data being selected from among compressed map data in a compressed map table, according to a rule; and storing the loaded compressed target map data and compressed candidate map data in the map cache region.

In accordance with an embodiment of the present invention, a memory system may include: a memory device suitable for storing map data and user data corresponding to the map data; and a controller suitable for receiving a read request for sequential target user data, and controlling the memory device, wherein the controller comprises: a memory comprising a map cache region in which the map data is stored; and a processor suitable for determining whether compressed target map data corresponding to the read request are retrieved from the map cache region, loading the compressed target map data and compressed candidate map data from the memory device when the compressed target map data are not retrieved from the map cache region, the compressed candidate map data being selected from among compressed map data in a compressed map table according to a rule, and storing the loaded compressed target map data and compressed candidate map data in the map cache region.

In accordance with an embodiment of the present invention, a memory system may include: a memory device suitable for storing map data and user data corresponding to the map data; and a controller including a memory having a map cache region, the controller suitable for: receiving a read request for sequential target user data; determining whether compressed target map data corresponding to the read request are retrieved from the map cache region; when the compressed target map data are not retrieved from the map cache region, loading the compressed target map data and compressed map data adjacent to the compressed target map data from the memory device; and storing the loaded compressed target map data and adjacent compressed map data in the map cache region.

### BRIEF DESCRIPTION OF THE DRAWINGS

The description herein makes reference to the accompanying drawings wherein like reference numerals refer to like parts throughout the several views, and wherein:

FIG. 1 is a block diagram illustrating a data processing system including a memory system in accordance with an embodiment of the present disclosure;

FIG. 2 is a schematic diagram illustrating a memory device of a memory system in accordance with an embodiment of the present disclosure;

FIG. 3 is a circuit diagram illustrating a memory cell array of a memory block in a memory device in accordance with an embodiment of the present disclosure;

FIG. 4 is a schematic diagram illustrating a three-dimensional structure of a memory device in accordance with an embodiment of the present disclosure;

FIG. 5 is a block diagram of a memory system in accordance with an embodiment of the present disclosure;

FIG. 6 illustrates a map table in accordance with an embodiment of the present disclosure;

FIG. 7 illustrates a compressed map table in accordance with an embodiment of the present disclosure;

FIG. 8 is a flowchart illustrating an operation process of a memory system in accordance with an embodiment of the present disclosure;

FIGS. 9A and 9B are flowcharts illustrating an operation process of a memory system in accordance with an embodiment of the present disclosure; and

FIGS. 10 to 18 are schematic diagrams illustrating exemplary applications of a data processing system, in accordance with various embodiments of the present invention.

### DETAILED DESCRIPTION

Various embodiments of the disclosure are described below in more detail with reference to the accompanying drawings. However, elements and features of the present invention may be configured or arranged to form other embodiments, which may be modifications or variations of any of the disclosed embodiments. Thus, the present invention is not limited to the embodiments set forth herein. Rather, the described embodiments are provided so that this disclosure is thorough and complete and fully conveys the present invention to those skilled in the art to which this invention pertains. Throughout the disclosure, like reference numerals refer to like parts throughout the various figures and examples of the disclosure. It is noted that reference to “an embodiment” or the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance may be termed a second or third element in another instance without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present. Whether two elements are directly or indirectly connected/coupled, communication between the two elements may be wired or wireless, unless stated or the context indicates otherwise.

The terminology used herein is for the purpose of describing particular embodiments and is not intended to be limiting of the present invention.

As used herein, singular forms are intended to include the plural forms and vice versa, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

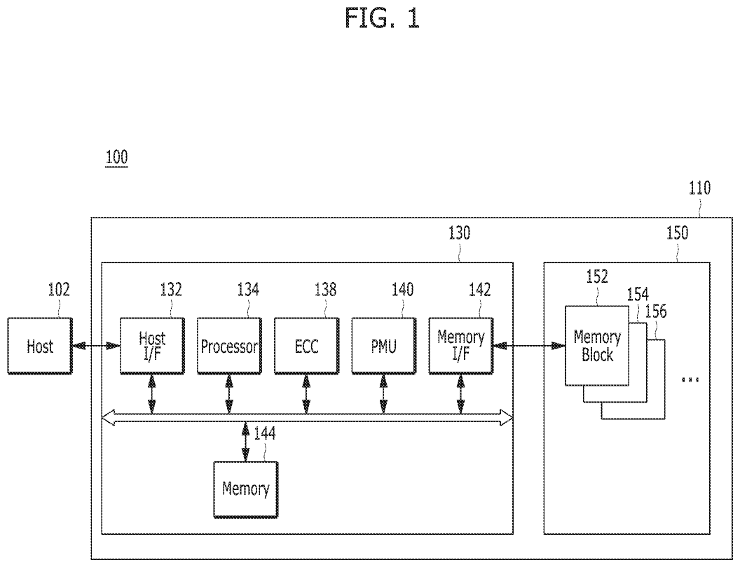

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include, for example, any of a variety of portable electronic devices such as a mobile phone, an MP3 player and a laptop computer or an electronic device such as a desktop computer, a game player, a television (TV), a projector, and the like.

The memory system 110 may operate or perform a specific function or operation in response to a request from the host 102 and, particularly, may store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device such as a dynamic random access memory (DRAM) and/or a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM), and/or a flash memory.

The memory system 110 may include a controller 130 and a memory device 150. The memory device 150 may store data to be accessed by the host 102, and the controller 130 may control storage of data in the memory device 150.

The controller 130 and the memory device 150 may be integrated into a single semiconductor device, which may be included in any of the various types of memory systems as exemplified above.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device that retains data stored therein even while an electrical power is not supplied. The memory device 150 may store data provided from the host 102 through a write operation, and provide data stored therein to the host 102 through a read operation. The memory device 150 may include a plurality of memory blocks 152 to 156, each of which may include a plurality of pages. Each of the plurality of pages may include a plurality of memory cells to which a plurality of word lines (WL) are electrically coupled.

The controller 130 may control overall operations of the memory device 150, such as read, write, program and erase operations. For example, the controller 130 may control the memory device 150 in response to a request from the host 102. The controller 130 may provide the data, read from the memory device 150, to the host 102, and/or may store the data, provided by the host 102, into the memory device 150.

The controller 130 may include a host interface (I/F) 132, a processor 134, an error correction code (ECC) component 138, a power management unit (PMU) 140, a memory interface (I/F) 142, and a memory 144 all operatively coupled via an internal bus.

The host interface 132 may process commands and data provided from the host 102, and may communicate with the host 102 through at least one of various interface protocols such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), small computer system interface (SCSI), enhanced small disk interface (ESDI), and integrated drive electronics (IDE).

The ECC component 138 may detect and correct errors in the data read from the memory device 150 during the read operation. When the number of the error bits is greater than or equal to a threshold number of correctable error bits, the ECC component 138 may not correct error bits but instead may output an error correction fail signal indicating failure in correcting the error bits.

The ECC component 138 may perform an error correction operation based on a coded modulation such as a low density parity check (LDDC) code, a Bose-Chaudhur-Hocquenghem (BCH) code, a turbo code, a Reed-Solomon (RS) code, a convolution code, a recursive systematic code (RSC), a trellis-coded modulation (TCM), a Block coded modulation (BCM), and the like. The ECC component 138 may include all or some of circuits, modules, systems or devices for performing the error correction operation based on at least one of the above described codes.

The PMU 140 may provide and manage power of the controller 130.

The memory interface 142 may serve as an interface for handling commands and data, transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134, when the memory device 150 is a flash memory and, in particular, a NAND flash memory.

The memory 144 may serve as a working memory of the memory system 110 and the controller 130, and may store temporary or transactional data for operating or driving the memory system 110 and the controller 130. The controller 130 may control the memory device 150 in response to a request from the host 102. The controller 130 may deliver data read from the memory device 150 into the host 102, may store data entered through the host 102 within the memory device 150. The memory 144 may be used to store data required for the controller 130 and the memory device 150 in order to perform these operations.

The memory 144 may be implemented with a volatile memory. The memory 144 may be implemented with a static random access memory (SRAM) or a dynamic random access memory (DRAM). Although FIG. 1 shows the memory 144 disposed within the controller 130, the disclosure is not limited thereto. That is, the memory 144 may be located within or externally to the controller 130. For instance, the memory 144 may be embodied by an external volatile memory having a memory interface transferring data and/or signals transferred between the memory 144 and the controller 130.

The processor 134 may control the overall operations of the memory system 110. The processor 134 may drive or execute a firmware to control the overall operations of the memory system 110. The firmware may be referred to as a flash translation layer (FTL).

An FTL may perform an operation as an interface between the host 102 and the memory device 150. The host 102 may transmit requests for write and read operations to the memory device 150 through the FTL.

The FTL may manage operations of address mapping, garbage collection, wear-leveling and the like. Particularly, the FTL may store map data. Therefore, the controller 130 may map a logical address, which is provided from the host 102, to a physical address of the memory device 150 through the map data. The memory device 150 may perform an operation like a general device because of the address mapping operation. Also, through the address mapping operation based on the map data, when the controller 130 updates data of a particular page, the controller 130 may program new data on another empty page and may invalidate old data of the particular page due to a characteristic of a flash memory device. Further, the controller 130 may store map data of the new data into the FTL.

The processor 134 may be implemented with a microprocessor or a central processing unit (CPU). The memory system 110 may include one or more processors 134.

A management unit (not shown) may be included in the processor 134. The management unit may perform bad block management of the memory device 150. The management unit may find bad memory blocks in the memory device 150, which are in unsatisfactory condition for further use, as well as perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. The bad blocks may significantly reduce the utilization efficiency of the memory device 150 having a 3D stack structure and the reliability of the memory system 100, and thus reliable bad block management is required.

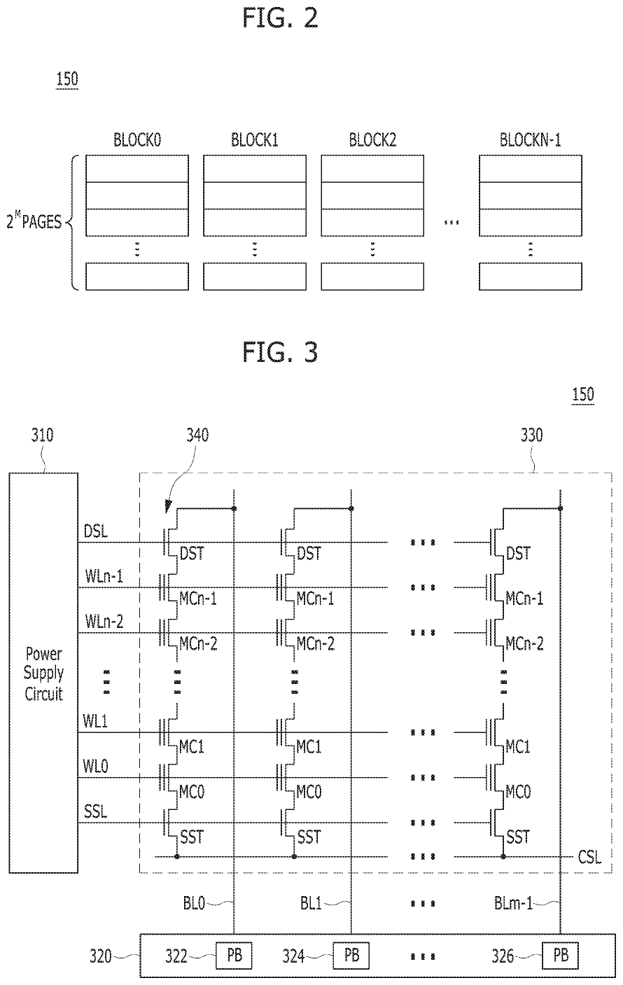

FIG. 2 is a schematic diagram illustrating a memory device, e.g., the memory device 150 of FIG. 1, in accordance with an embodiment of the present disclosure.

Referring to FIG. 2, the memory device 150 may include the plurality of memory blocks BLOCK 0 to BLOCKN-1, and each of the blocks BLOCK 0 to BLOCKN-1 may include a plurality of pages, for example, 2^{M} pages, the number of which may vary according to circuit design. The memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

FIG. 3 is a circuit diagram illustrating a memory block 330 in the memory device 150 in accordance with an embodiment of the present disclosure.

Referring to FIG. 3, the memory block 330 may correspond to any of the plurality of memory blocks 152 to 156 in the memory device 150 of the memory system 110.

The memory block 330 may include a plurality of cell strings 340 which are electrically coupled to bit lines BL0 to BLm-1, respectively. The cell string 340 of each column may include at least one drain select transistor DST and at least one source select transistor SST. A plurality of memory cells or a plurality of memory cell transistors MC0 to MCn-1 may be electrically coupled in series between the select transistors DST and SST. The respective memory cells MC0 to MCn-1 may be configured as single level cells (SLC) each of which may store 1 bit of information, or as multi-level cells (MLC) each of which may store a plurality of bits. The strings 340 may be electrically coupled to the corresponding bit lines BL0 to BLm-1, respectively. For reference, in FIG. 3, ‘DSL’ denotes a drain select line, ‘SSL’ denotes a source select line, and ‘CSL’ denotes a common source line.

While FIG. 3 only shows, as an example, that the memory block 330 is constituted with NAND flash memory cells, it is to be noted that the memory block 330 of the memory device 150 is not limited to a NAND flash memory. The memory block 330 may be realized by a NOR flash memory, a hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A power supply circuit 310 of the memory device 150 may supply word line voltages, for example, a program voltage, a read voltage and a pass voltage, to respective word lines according to an operation mode, as well as supply voltages to bulks, for example, well regions in which the memory cells are formed. The power supply circuit 310 may perform a voltage generating operation under the control of a control circuit (not shown). The power supply circuit 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read and write (read/write) circuit 320 of the memory device 150 may be controlled by the control circuit, and may serve as a sense amplifier or a write driver according to an operation mode. During a verification operation or a normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

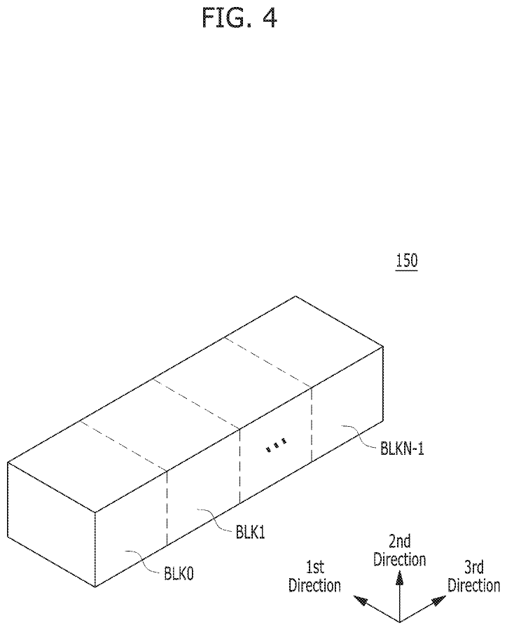

FIG. 4 is a schematic diagram illustrating a three-dimensional (3D) structure of a memory device, e.g., the memory device 150 in accordance with an embodiment of the present disclosure.

Specifically, as illustrated in FIG. 4, the memory device 150 may be embodied in a nonvolatile memory device having a 3D stack structure. When the memory device 150 has a 3D structure, the memory device 150 may include a plurality of memory blocks BLK0 to BLKN-1 each having a 3D structure (or a vertical structure). As an alternative to the 3D structure shown in FIG. 3, the memory device 150 may be configured as a two-dimensional (2D) structure.

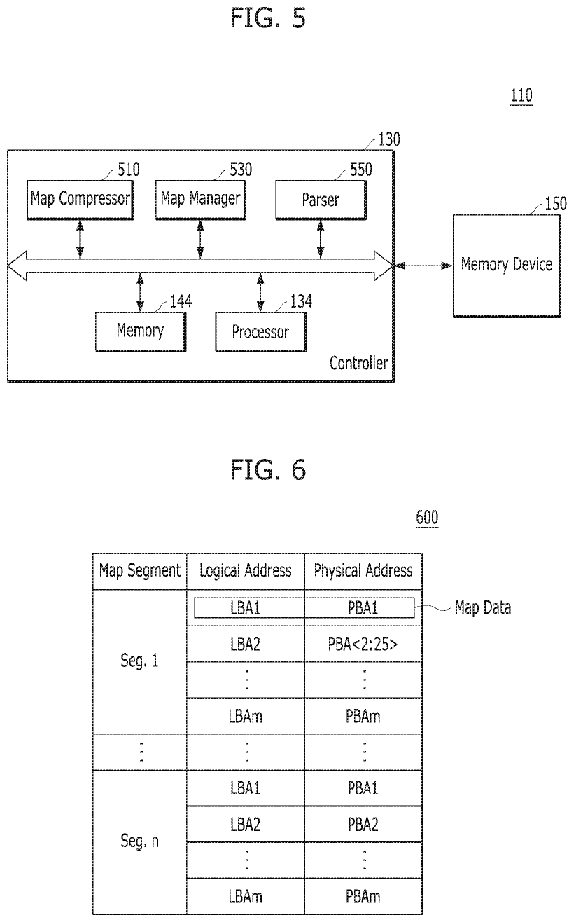

FIG. 5 is a block diagram of a memory system 110 in accordance with an embodiment. The structure of the memory system 110 has been described with reference to FIG. 1. With that in mind, FIG. 5 illustrates only core components of the memory system 110 in accordance with the present embodiment.

Referring to FIG. 5, the memory system 110 may include the controller 130 and the memory device 150.

The controller 130 may include the processor 134 and the memory 144 as described above, and further include a map compressor 510, a map manager 530 and a parser 550.

The processor 134 may control overall operations of the memory system 110. For example, when a write request for target user data is received from the host 102, the processor 134 may assign a location in the memory device 150, where the target user data are to be stored, based on the logical address of the target user data provided from the host 102, and then write the target user data in the location in the memory device 150. The location is considered a physical address. When a read request for target user data is received from the host 102, the processor 134 may check the mapping relationship between the physical address and the logical address received from the host 102, and then read the target user data based on the result of the check. The mapping relationship is defined by map data. If the processor 134 quickly checks the target map data where the target user data are stored, the read performance of the memory system 110 may be improved.

The memory 144 serving as a working memory of the processor 134 or the memory system 110 may temporarily store data which can be processed by the memory system 110. The memory 144 may include a map cache region capable of storing map data. The map cache region of the memory 144 may be configured as a part of the entire capacity of the memory 144. The processor 134 may quickly check the location of user data through the map data stored in the map cache region of the memory 144. Since the capacity of the map cache region is limited, map data corresponding to all user data stored in the memory device 150 cannot be stored in the map cache region. That is, the map cache region can store only a part of the entire map data. Therefore, the map cache region may store compressed map data, in order to store a large amount of map data.

However, when the target map data are not stored in the map cache region, the processor 134 may load the target map data from the memory device 150. The processor 134 may check an available space of the map cache region, and load the target map data from the memory device 150. The processor 134 may load map data (i.e., candidate map data) other than the target map data in advance, particularly, compressed map data (i.e., compressed candidate map data), in consideration of the available space of the map cache region.

The map compressor 510 may compress map data at a particular compression ratio, which may be predetermined. Specifically, the map compressor 510 may receive sequential map data corresponding to sequential user data from the processor 134, and compress the sequential map data to a particular size, which may be predetermined. For example, the processor 134 may sequentially assign the sequential user data to first to tenth physical addresses. In this case, the first to tenth physical addresses may correspond to map data for the respective sequential user data. That is, 10 items of map data for the sequential user data may be generated. The map compressor 510 may compress the map data into one piece of data, using a compression ratio of ‘ 1/10’. However, this is only an example; other suitable compression ratios may be used.

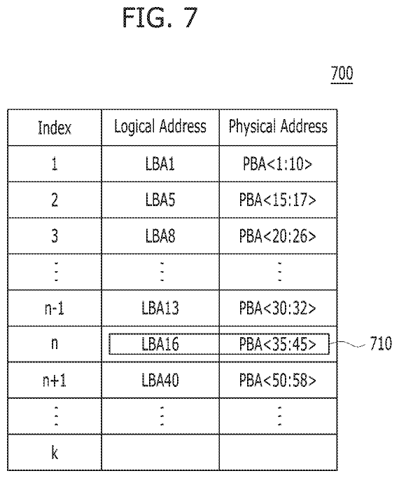

The map manager 530 may manage a map table 600 and a compressed map table 700. Specifically, the map manager 530 may generate and update the map table 600 and the compressed map table 700, based on the map data provided from the processor 134 and the map compressor 510. The map table 600 and the compressed map table 700 are described below with reference to FIGS. 6 and 7.

FIG. 6 illustrates the map table 600 in accordance with an embodiment.

Referring to FIG. 6, the map table 600 may include mapping information between logical and physical addresses, i.e., map data. Specifically, the map table 600 may include a plurality of map segments Seg. 1 to Seg. n. Each of the map segments Seg. 1 to Seg. n may include a plurality of logical addresses LBA1 to LBAm and a plurality of physical addresses PBA1 to PBAm. The plurality of logical addresses LBA1 to LBAm may respectively correspond to the physical addresses PBA1 to PBAm. The logical addresses and the physical addresses may correspond one-to-one or one-to-many.

When target user data corresponding to a write request received from the host 102 are non-sequential user data, the processor 134 may assign the first physical address PBA1 identifying a location where the target user data are to be stored, and generate map data to correspond to the first physical address PBA1 and the first logical address LBA1 which correspond to the target user data. The map manager 530 may update the map table 600 in order to reflect the map data.

When the target user data corresponding to the write request received from the host 102 are sequential user data, the processor 134 may assign second to 25th physical addresses PBA<2:25> identifying locations where the target user data are to be stored, and provide information regarding the assigned addresses to the map compressor 510. The map compressor 510 may generate compressed map data based on the provided information. The second logical address LBA2 may correspond to the second to 25th physical addresses PBA<2:25>. The map manager 530 may update the map table 600 in order to reflect the compressed map data.

In FIG. 6, the compressed physical address may be simply represented as start and end physical addresses such as PBA<2:25>, but such representation may also indicate address length. For example, PBA<2:25> may indicate a physical address of which the start physical address is ‘PBA2’, the address length is ‘23’, and the end physical address is ‘PBA25’. However, this is only an example. Other suitable ways of representing a compressed physical address may be used.

The processor 134 may store the map table 600 in the memory device 150 according to a request (for example, flush command) of the host 102. Further, the processor 134 may store the map table 600 in the memory 144. When a read request from the host 102 is provided to the controller 130, the processor 134 can quickly check map data corresponding to the read request based on the map table 600 stored in the memory 144 or the memory device 150, and read data corresponding to the read request based on the map data found in the check operation.

FIG. 7 illustrates the compressed map table 700 in accordance with an embodiment.

Referring to FIG. 7, the compressed map table 700 may include compressed map data corresponding to a plurality of indexes, for example, k indexes: Index_1 to Index_k. For example, a second index Index_2 may correspond to map data indicating the mapping relationship between the fifth logical address LBAS and the 15th to 17th physical addresses PBA<15:17>.

Referring back to FIG. 5, the map compressor 510 may compress map data corresponding to sequential user data, and then provide information on the compressed map data to the map manager 530. The map manager 530 may generate and update the compressed map table 700 by assigning the compressed map data to the respective indexes based on the provided compressed map data.

The processor 134 may store the compressed map table 700 in the memory device 150 according to a request (for example, flush command) of the host 102. Further, the processor 134 may store the compressed map table 700 in the memory 144.

When the target map data are not present in the map cache region of the memory 144, the processor 134 may load the target map data from the memory device 150. When the target map data are compressed map data, the processor 134 may load compressed map data (i.e., candidate map data) other than the compressed target map data in advance, depending on the available space of the map cache region.

The following assumptions are made for purposes of the present discussion. Target map data for target user data are compressed map data, when the target user data corresponding to a read request from the host 102 are sequential user data. Furthermore, the target map data are map data 710 corresponding to an n-th index Index_n of the map table 700. Furthermore, the size of the map cache region is 2 MB. However, this is only an example; the present invention is not limited thereto.

Referring back to FIG. 7, the processor 134 of FIG. 5 may check for the compressed map data 710 corresponding to the n-th index Index_n using the compressed map table 700. When it is determined in the check operation that the target map data for the target user data are not stored in the map cache region of the memory 144, the processor 134 may load the compressed target map data 710 corresponding to the n-th index. Furthermore, the processor 134 may check the available space of the map cache region within the memory 144, and load compressed map data written to the compressed map table 700 after the n-th index, as well as the compressed target map data corresponding to the n-th index. When the map cache region has sufficient available space, the processor 134 may load a plurality of compressed map data as well as the compressed target map data 710. Specifically, when the available space of the map cache region is greater than or equal to a threshold value, the processor 134 may load compressed map data corresponding to indexes ranging from the n-th index Index_n to (n+j)-th index Index_(n+j), as well as the compressed target map data 710 corresponding to the n-th index Index_n. The variable ‘j’ may be decided by the processor 134 based on the available space of the map cache space. The threshold value may be predetermined.

For example, when the available space of the map cache region is greater than or equal to a threshold value (e.g., 1.5 MB), the processor 134 may determine that the map cache region has sufficient available space, and load compressed map data corresponding to indexes ranging from the n-th index to (n+5)-th index, as well as the compressed target map data 710 corresponding to the n-th index. For another example, when the available space of the map cache region is less than a threshold value (e.g., 0.5 MB), the processor 134 may load only the compressed target map data 710 corresponding to the n-th index. That is, the processor 134 may decide the number of compressed map data which can be loaded with the compressed target map data, depending on the available space of the map cache region.

Referring back to FIG. 5, the parser 550 may parse the map data stored in the map cache region by the processor 134. For example, the parser 550 may parse the compressed map data stored in the map cache region of the memory 144. Based on the map data parsed by the parser 550, the processor 134 may read user data corresponding to the map data from the memory device 150.

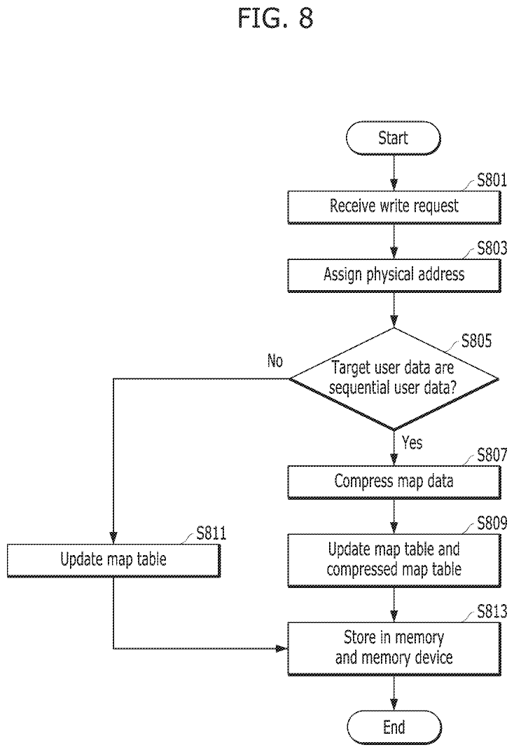

FIG. 8 is a flowchart illustrating an operation process of a memory system, e.g., the memory system 110 of FIG. 5, in accordance with an embodiment. In particular, FIG. 8 illustrates an operation process of the memory system 110 when a write request is received from the host 102.

Referring to FIG. 8, at step S801, the controller 130 may receive a write request from the host 102.

At step S803, the processor 134 may assign a physical address to store target user data corresponding to the write request.

At step S805, the processor 134 may determine whether the target user data are sequential user data. However, the order of step S805 with respect to step S804 may be changed. That is, in an embodiment, the processor 134 may determine whether the target user data are sequential user data, when the write request is received from the host 102, that is, right after step S801.

When it is determined that the target user data are sequential user data (Yes at step S805), the map compressor 510 may compress the target map data based on physical address information received from the processor 134 at step S807.

At step S809, the map compressor 510 may provide information on the compressed target map data to the map manager 530. The map manager 530 may update the map table 600 and the compressed map table 700 in order to reflect the compressed target map data.

When it is determined that the target user data are non-sequential user data (No at step S805), the processor 134 may provide target map data corresponding to the target user data to the map manager 530, and the map manager 530 may update the map table 600 to reflect the target map data, at step S811.

At step S813, the processor 134 may store the map table 600 and the compressed map table 700, which are updated at step S809, or the map table 600, which is updated at step S811, in the memory device 150 and in the memory 144.

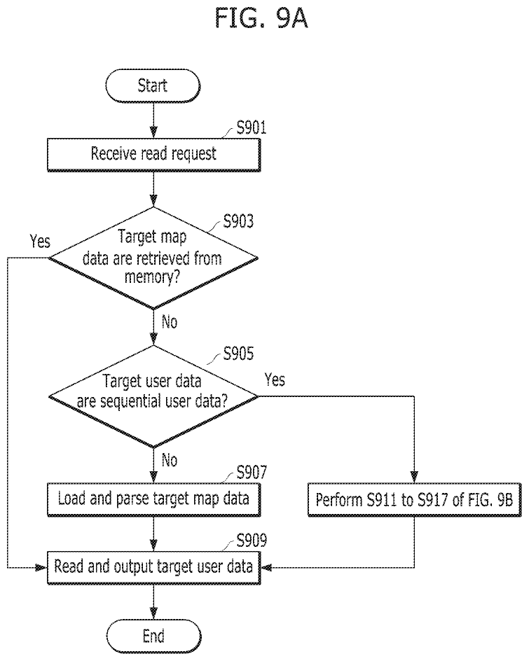

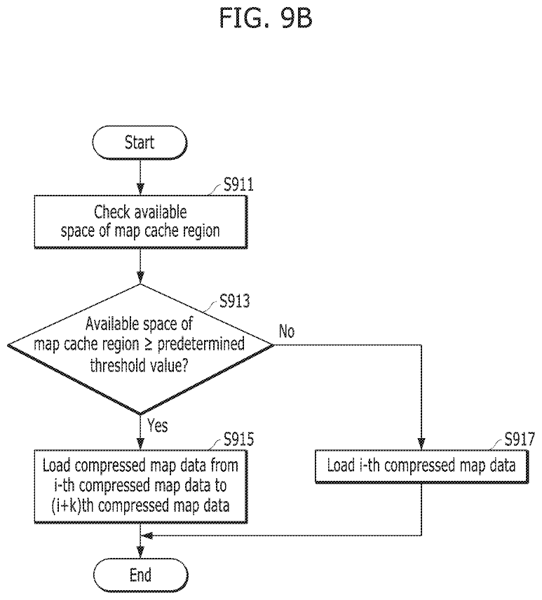

FIGS. 9A and 9B are flowcharts illustrating an operation process of a memory system, e.g., the memory system 110 of FIG. 5, in accordance with an embodiment. In particular, FIGS. 9A and 9B illustrate an operation process of the memory system 110 when a read request is received from the host 102.

Referring to FIG. 9A, at step S901, the controller 130 may receive a read request from the host 102 of FIG. 1.

At step S903, the processor 134 may retrieve target map data corresponding to the read request from the memory 144.

When the target map data are retrieved from the memory 144 (Yes at step S903), the processor 134 may read the target user data stored in the memory device 150 based on the retrieved target map data at step S909. Furthermore, the controller 130 may output the read target user data to the host 102. When the target user data read from the memory device 150 by the processor 134 contains an error, the error may be corrected through ECC decoding.

When the target map data are not retrieved from the memory 144 (No at step S903), the processor 134 may determine whether the target user data are sequential user data at step S905. However, the order of step S905 may be changed. That is, the processor 134 may determine whether the target user data are sequential user data, when the read request is received from the host 102, that is, right after step S901.

When the target user data are not sequential user data (No at step S905), the processor 134 may load the target map data stored in the memory device 150 into the memory 144 at step S907. The parser 550 may parse the target map data loaded in the memory 144.

At step S909, the processor 134 may read the target user data corresponding to the parsed target map data from the memory device 150. Furthermore, the controller 130 may output the read target user data to the host 102. When the target user data read from the memory device 150 by the processor 134 contains an error, the error may be corrected through ECC decoding.

When the target user data are sequential user data (Yes at step S905), the controller 130 may perform steps S911 to S917 illustrated in FIG. 9B.

FIG. 9B is a flowchart illustrating an operation process of a controller, e.g., the controller 130 of FIG. 5, in accordance with an embodiment. In particular, FIG. 9B illustrates a process in which the processor 134 of the controller 130 loads compressed target map data into the memory 144, when the target user data are sequential user data.

Referring to FIG. 9B, at step S911, the processor 134 may check the available space of the map cache region within the memory 144.

When it is determined that the available space of the map cache region is greater than or equal to a threshold value (Yes at step S913), the processor 134 may load compressed map data into the memory 144 from the memory device 150 based on the compressed map table 700 at step S915. The compressed map data range from compressed map data corresponding to an i-th index to compressed map data corresponding to an (i+k)th index. The compressed map data corresponding to the i-th index may indicate the target map data corresponding to the read request. Furthermore, k represents a value which is set according to the available space of the map cache region, as determined by the processor 134 in the check operation (step S911). For example, in the case in which the target map data corresponding to the read request are compressed map data corresponding to the second index, k is set to ‘3’. The processor 134 may load compressed map data from the memory device 150 into the memory 144. The compressed map data range from compressed map data corresponding to the second index to compressed map data corresponding to the fifth index.

When the available space of the map cache region is less than the threshold value (No at step S913), the processor 134 may load only the compressed map data corresponding to the i-th index into the memory 144 from the memory device 150 at step S917.

As described above, the memory system 110 in accordance with embodiments may load target map data and other candidate map data in advance, and store the map data in the memory 144, thereby saving time required for loading the map data in the future. As a result, the read performance of the memory system 110 may be improved.

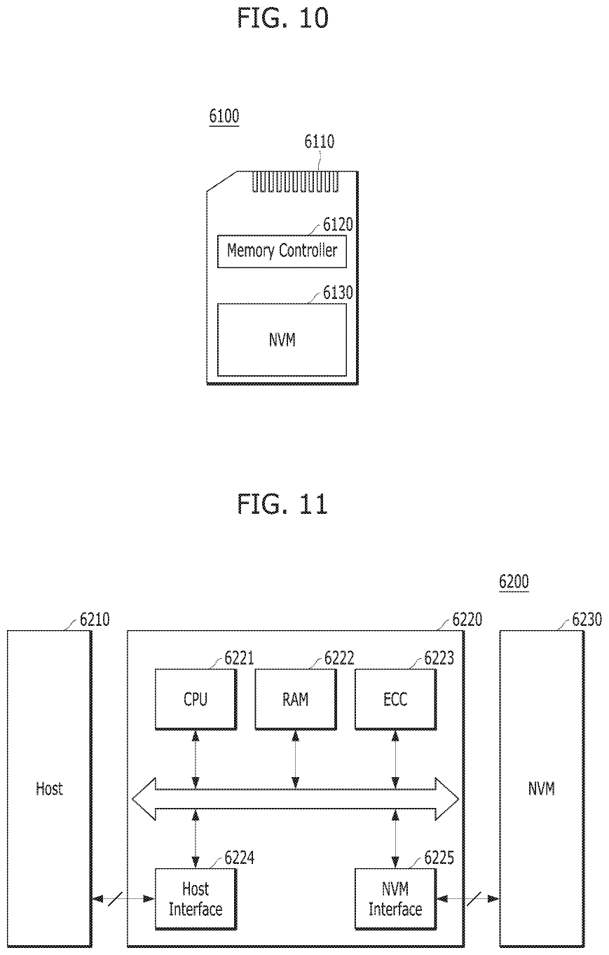

A data processing system and electronic devices which may be constituted with the memory system 110 including the memory device 150 and the controller 130, which are described above by referring to FIGS. 1 to 9B, are described in detail below with reference to FIGS. 10 to 18.

FIGS. 10 to 18 are diagrams schematically illustrating exemplary applications of the data processing system of FIGS. 1 to 9B according to various embodiments.

FIG. 10 is a diagram schematically illustrating an example of the data processing system including the memory system in accordance with an embodiment. FIG. 10 schematically illustrates a memory card system 6100 to which the memory system may be applied.

Referring to FIG. 10, the memory card system 6100 may include a memory controller 6120, a memory device 6130 and a connector 6110.

More specifically, the memory controller 6120 may be connected to the memory device 6130, and may be configured to access the memory device 6130. The memory device 6130 may be embodied by a nonvolatile memory (NVM). By the way of example but not limitation, the memory controller 6120 may be configured to control read, write, erase and background operations on the memory device 6130. The memory controller 6120 may be configured to provide an interface between the memory device 6130 and a host (not shown) and/or drive firmware for controlling the memory device 6130. That is, the memory controller 6120 may correspond to the controller 130 in the memory system 110 described with reference to FIGS. 1 to 9B, while the memory device 6130 may correspond to the memory device 150 described with reference to FIGS. 1 to 9B.

Thus, as shown in FIG. 1, the memory controller 6120 may include a random access memory (RAM), a processor, a host interface, a memory interface and an error correction component. The memory controller 130 may further include the elements described in FIG. 1.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi), and Bluetooth. Thus, the memory system and the data processing system may be applied to wired and/or wireless electronic devices, particularly mobile electronic devices.

The memory device 6130 may be implemented by a nonvolatile memory. For example, the memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may be so integrated to form a solid state drive (SSD). Also, the memory controller 6120 and the memory device 6130 may be so integrated to form a memory card such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), a secured digital (SD) card (e.g., SD, miniSD, microSD and SDHC), and/or a universal flash storage (UFS),

FIG. 11 is a diagram schematically illustrating another example of a data processing system 6200, including a memory system, in accordance with an embodiment.

Referring to FIG. 11, the data processing system 6200 may include a memory device 6230 having one or more nonvolatile memories (NVMs) and a memory controller 6220 for controlling the memory device 6230. The data processing system 6200 may serve as a storage medium such as a memory card (e.g., CF, SD, micro-SD or the like) or USB device, as described with reference to FIG. 1. The memory device 6230 may correspond to the memory device 150 in the memory system 110 described in FIGS. 1 to 9B, and the memory controller 6220 may correspond to the controller 130 in the memory system 110 described in FIGS. 1 to 9B.

The memory controller 6220 may control a read, write, or erase operation on the memory device 6230 in response to a request of the host 6210, and the memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control the operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may correspond to the ECC component 138 of the controller 130 illustrated in FIG. 1. As described with reference to FIG. 1, the ECC circuit 6223 may generate an error correction code (ECC) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. In this case, the ECC circuit 6223 may correct an error using the parity bit. For example, as described with reference to FIG. 1, the ECC circuit 6223 may correct an error using Low Density Parity Check (LDPC) code, Bose-Chaudhri-Hocquenghem (BCH) code, turbo code, Reed-Solomon code, convolution code, Recursive Systematic Code (RSC) or coded modulation such as Trellis-Coded Modulation (TCM) or Block coded modulation (BCM).

The memory controller 6220 may transmit to, and/or receive from, the host 6210 data or signals through the host interface 6224, and may transmit to, and/or receive from, the memory device 6230 data or signals through the NVM interface 6225. The host interface 6224 may be connected to the host 6210 through a parallel advanced technology attachment (PATA) bus, a serial advanced technology attachment (SATA) bus, a small computer system interface (SCSI), a universal serial bus (USB), a peripheral component interconnect-express (PCIe), or a NAND interface. The memory controller 6220 may have a wireless communication function with a mobile communication protocol such as wireless fidelity (WiFi) or Long Term Evolution (LTE). The memory controller 6220 may be connected to an external device, e.g., the host 6210, or another external device, and then transmit and/or receive data to and/or from the external device. As the memory controller 6220 is configured to communicate with the external device through one or more of various communication protocols, the memory system and the data processing system may be applied to wired and/or wireless electronic devices, particularly a mobile electronic device.

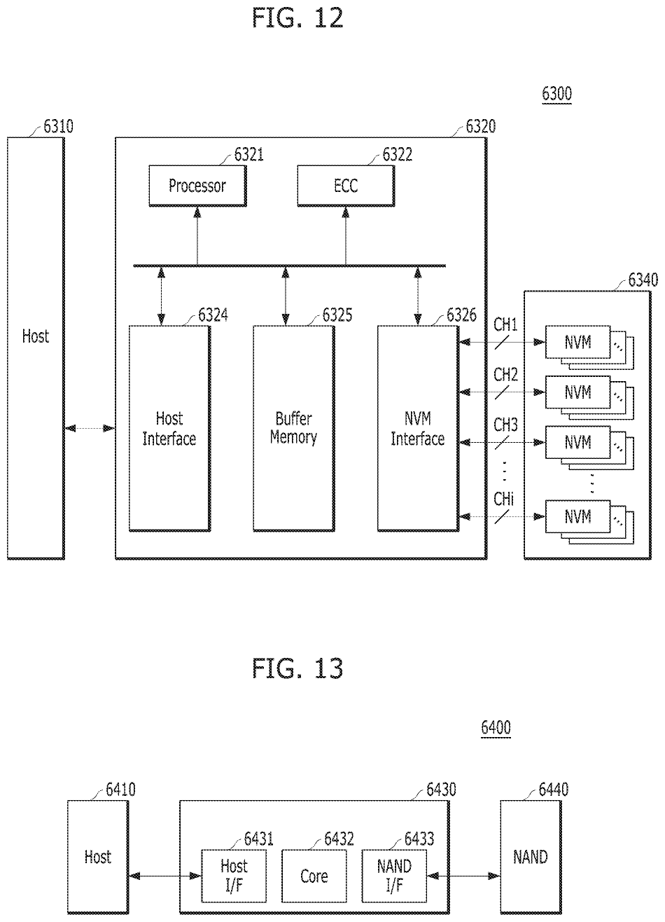

FIG. 12 is a diagram schematically illustrating another example of the data processing system including the memory system in accordance with an embodiment. FIG. 12 schematically illustrates a solid state drive (SSD) 6300 to which the memory system may be applied.

Referring to FIG. 12, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by any of various volatile memories such as a dynamic random access memory (DRAM), a synchronous DRAM (SDRAM), a double data rate (DDR) SDRAM, a low power DDR (LPDDR) SDRAM and a graphics RAM (GRAM) or nonvolatile memories such as a ferroelectric RAM (FRAM), a resistive RAM (RRAM or ReRAM), a spin-transfer torque magnetic RAM (STT-MRAM) and a phase-change RAM (PRAM). For the purpose of description, FIG. 12 illustrates that the buffer memory 6325 is disposed in the controller 6320, but the buffer memory 6325 may be external to the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, i.e., RAID level information of the write command provided from the host 6310 in the SSDs 6300, and may output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 13 is a diagram schematically illustrating another example of the data processing system including the memory system in accordance with an embodiment. FIG. 13 schematically illustrates an embedded Multi-Media Card (eMMC) 6400 to which the memory system may be applied.

Referring to FIG. 13, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface (I/F) 6431 and a memory interface, for example, a NAND interface (I/F) 6433.

The core 6432 may control the operations of the eMMC 6400, the host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I or UHS-II interface.

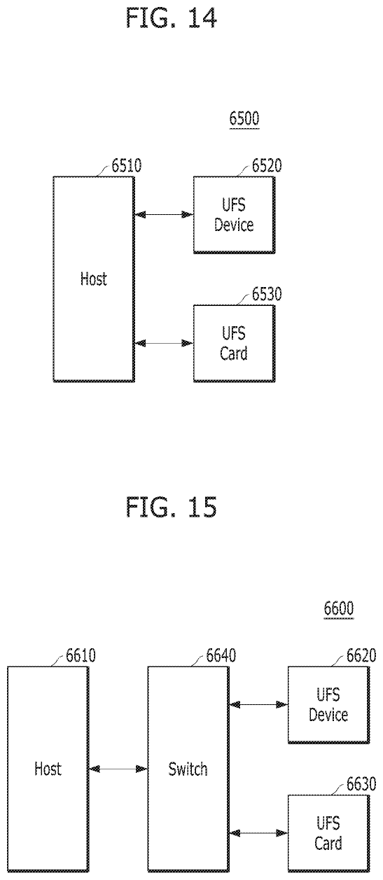

FIGS. 14 to 17 are diagrams schematically illustrating other examples of the data processing system including the memory system in accordance with embodiments. FIGS. 14 to 17 schematically illustrate universal flash storage (UFS) systems to which the memory system may be applied.

Referring to FIGS. 14 to 17, the UFS systems 6500, 6600, 6700 and 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired and/or wireless electronic devices or particularly mobile electronic devices, the UFS devices 6520, 6620, 6720, 6820 may serve as embedded UFS devices. The UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700 and 6800 may communicate with external devices, e.g., wired and/or wireless electronic devices or particularly mobile electronic devices through UFS protocols. The UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 11 to 13, and the UFS cards 6530, 6630, 6730, 6830 may be embodied in the form of the memory card system 6100 described with reference to FIG. 10.

Furthermore, in the UFS systems 6500, 6600, 6700 and 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, e.g., universal storage bus (USB) Flash Drives (UFDs), multi-media card (MMC), secure digital (SD), mini-SD, and micro-SD.

In the UFS system 6500 illustrated in FIG. 14, each of the host 6510, the UFS device 6520 and the UFS card 6530 may include UniPro. The host 6510 may perform a switching operation to communicate with at least one of the UFS device 6520 and the UFS card 6530. The host 6510 may communicate with the UFS device 6520 or the UFS card 6530 through link layer switching, e.g., L3 switching at the UniPro. In this case, the UFS device 6520 and the UFS card 6530 may communicate with each other through a link layer switching at the UniPro of the host 6510. FIG. 14 illustrates, as an example, the configuration in which one UFS device 6520 and one UFS card 6530 are connected to the host 6510. However, a plurality of UFS devices and UFS cards may be connected in parallel or in the form of a star to the host 6510, and a plurality of UFS cards may be connected in parallel or in the form of a star to the UFS device 6520 or connected in series or in the form of a chain to the UFS device 6520. Herein, the form of a star means an arrangement that a single device is coupled with plural other devices or cards for centralized control.

In the UFS system 6600 illustrated in FIG. 15, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. FIG. 15 illustrates as an example, the configuration in which one UFS device 6620 and one UFS card 6630 are connected to the switching module 6640. However, a plurality of UFS devices and UFS cards may be connected in parallel or in the form of a star to the switching module 6640, and a plurality of UFS cards may be connected in series or in the form of a chain to the UFS device 6620.

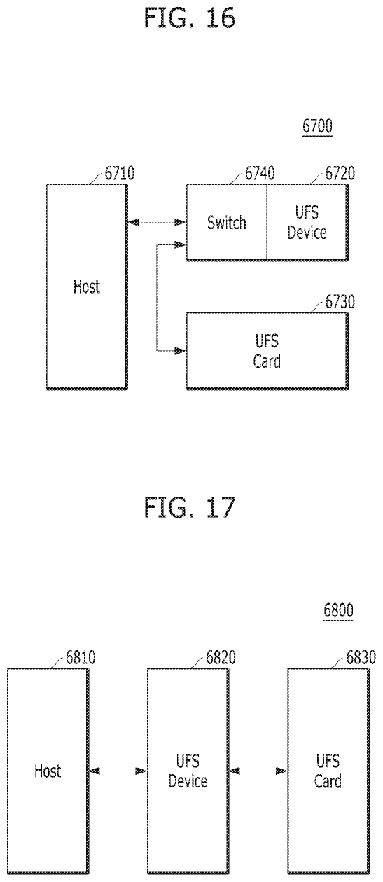

In the UFS system 6700 illustrated in FIG. 16, each of the host 6710, the UFS device 6720 and the UFS card 6730 may include UniPro. The host 6710 may communicate with the UFS device 6720 or the UFS card 6730 through a switching module 6740 performing a switching operation, for example, the switching module 6740 which performs link layer switching at the UniPro, for example, L3 switching. In this case, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. FIG. 16 illustrates as an example, the configuration in which one UFS device 6720 and one UFS card 6730 are connected to the switching module 6740. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 17, each of the host 6810, the UFS device 6820 and the UFS card 6830 may include M-PHY and UniPro. The UFS device 6820 may perform a switching operation to communicate with the host 6810 and the UFS card 6830. The UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. Here, the host 6810 and the UFS card 6830 may communicate with each other through target ID switching between the M-PHY and UniPro modules of the UFS device 6820. FIG. 17 illustrates an embodiment in which one UFS device 6820 is connected to the host 6810 and one UFS card 6830 is connected to the UFS device 6820. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

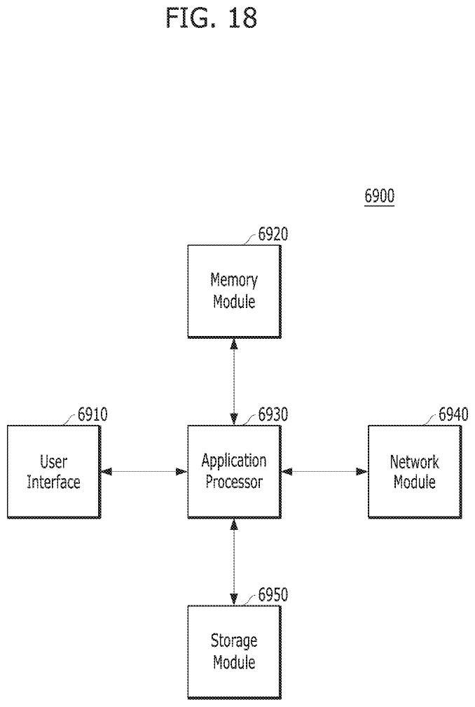

FIG. 18 is a diagram schematically illustrating another example of the data processing system including the memory system in accordance with an embodiment. FIG. 18 is a diagram schematically illustrating a user system 6900 to which the memory system may be applied.

Referring to FIG. 18, the user system 6900 may include a user interface 6910, a memory module 6920, an application processor 6930, a network module 6940, and a storage module 6950.

More specifically, the application processor 6930 may drive components included in the user system 6900, for example, an operating system (OS), and include controllers, interfaces and a graphic engine which control the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, DDR2 SDRAM, DDR3 SDRAM, LPDDR SDARM, LPDDR3 SDRAM or LPDDR3 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but may also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices, particularly mobile electronic devices. Therefore, the memory system and the data processing system can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 12 to 17.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control the operations of the mobile electronic device, and the network module 6940 may serve as a communication module for controlling wired and/or wireless communication with an external device. The user interface 6910 may display data processed by the processor 6930 on a display and touch module of the mobile electronic device, or support a function of receiving data from the touch panel.

While the present invention has been illustrated and described with respect to specific embodiments, it will be apparent to those skilled in the art in light of the present disclosure that various changes and modifications may be made without departing from the spirit and scope of the invention as determined in the following claims.

What is claimed is:

1. An operating method of a memory system, comprising:
receiving a read request for sequential target user data;
determining whether compressed target map data corresponding to the read request are retrieved from a map cache region within a memory;
loading the compressed target map data and compressed candidate map data from a memory device of the memory system, when the compressed target map data are not retrieved from the map cache region, the compressed candidate map data being selected from among compressed map data in a compressed map table, according to a rule; and
storing the loaded compressed target map data and compressed candidate map data in the map cache region.

2. The operating method of claim 1, wherein the compressed map table comprises indexes respectively corresponding to portions of the compressed map data.

3. The operating method of claim 2, wherein the loading of the compressed target map data and the compressed candidate map data comprises setting compressed map data to the compressed candidate map data, the compressed map data corresponding to an index entered after an index corresponding to the compressed target map data among the compressed map data in the compressed map table.

4. The operating method of claim 1, further comprising checking available space of the map cache region.

5. The operating method of claim 4, wherein the loading of the compressed target map data and the compressed candidate map data comprises selecting the compressed candidate map data according to the available space of the map cache region, which is the basis of the rule.

6. The operating method of claim 1, further comprising:
receiving a write request for the sequential target user data;
assigning target map data corresponding to the sequential target user data;
compressing the target map data into the compressed target map data using a compression ratio; and
storing the compressed map data in the memory device.

7. The operating method of claim 6, wherein the compressing of the target map data comprises compressing the target map data using a start physical address and address length.

8. The operating method of claim 6, further comprising updating the compressed map table to reflect the compressed target map data.

9. The operating method of claim 1, further comprising:
parsing the compressed target map data;
reading the sequential target user data from the memory device based on the parsed target map data; and
outputting the read target user data.

10. The operating method of claim 1, further comprising, when the compressed target map data are retrieved from the map cache region:
parsing the compressed target map data;
reading the sequential target user data from the memory device based on the parsed target map data; and
outputting the read target user data.

11. A memory system comprising:
a memory device suitable for storing map data and user data corresponding to the map data; and
a controller suitable for receiving a read request for sequential target user data, and controlling the memory device,
wherein the controller comprises:
a memory comprising a map cache region in which the map data is stored; and
a processor suitable for determining whether compressed target map data corresponding to the read request are retrieved from the map cache region, loading the compressed target map data and compressed candidate map data from the memory device when the compressed target map data are not retrieved from the map cache region, the compressed candidate map data being selected from among compressed map data in a compressed map table according to a rule, and storing the loaded compressed target map data and compressed candidate map data in the map cache region.

12. The memory system of claim 11, wherein the controller further comprises a map manager suitable for managing the compressed map table, and
the compressed map table comprises indexes respectively corresponding to portions of the compressed map data.

13. The memory system of claim 12, wherein the processor sets compressed map data to the compressed candidate map data, the compressed map data corresponding to an index entered after an index corresponding to the compressed target map data among the compressed map data in the compressed map table.

14. The memory system of claim 11, wherein the processor checks available space of the map cache region.

15. The memory system of claim 14, wherein the processor selects the compressed candidate map data according to the available space of the map cache region, which is the basis of the rule.

16. The memory system of claim 11, wherein the controller further comprises a map compressor suitable for compressing sequential map data corresponding to sequential user data using a compression ratio,
wherein, when the controller receives a write request for the sequential target user data, the processor assigns target map data corresponding to the sequential target user data, and stores the compressed target map data in the memory device, the compressed target map data being obtained by compressing the target map data at the compression ratio through the map compressor.

17. The memory system of claim 16, wherein the map compressor compresses the sequential map data using a start physical address and address length.

18. The memory system of claim 16, wherein the map manager updates the compressed map table to reflect the compressed target map data.

19. The memory system of claim 11, wherein the controller further comprises a parser suitable for parsing the map data,
wherein the controller parses the compressed target map data, reads the sequential target user data from the memory device based on the parsed target map data, and outputs the read target user data.

20. The memory system of claim 11, wherein the controller further comprises a parser suitable for parsing the map data,
wherein when the compressed target map data are retrieved from the map cache region, the controller parses the compressed target map data, reads the sequential target user data from the memory device based on the parsed target map data, and outputs the read target user data.
